(19) United States
(12) Patent Application Publication
(10) Pub. No.: US 2003/0211343 A1
(43) Pub. Date: Nov. 13, 2003

(54) Metal surface treatment agent

(76) Inventors: Yasuhiro Kinoshita, Kanagawa (JP); Kazunari Hamamura, Kanagawa (JP); Ryousuke Sako, Kanagawa (JP)

Correspondence Address: HENKEL CORPORATION, 2500 RENAISSANCE BLVD, STE 200, GULPH MILLS, PA, 19406, US

(21) Appl. No.: 10/204,168

(22) PCT Filed: Feb. 20, 2001
(86) PCT No.: PCT/US01/05257

(30) Foreign Application Priority Data
Feb. 18, 2000 (JP) 2000/41339

(51) Int. Cl. B32B 15/04

(52) U.S. Cl. 428/457; 428/461

(57) ABSTRACT

The object of the present invention is to provide a metal surface treatment agent which improves the press molding workability of metal materials, and which can form a coating film that is superior in terms of at least one of moisture resistance and coating film stripping characteristics. The metal surface treatment agent of the present invention comprises (A) a copolymer which comprises (a) styrene and (b) a vinyl compound with carboxyl groups that is copolymerizable with styrene, and (B) a lubricating agent. The metal surface treatment agent is characterized by the fact that the weight ratio of component (a) to component (b) in the aforementioned polymer (A), i.e., (a)/(b) (weight ratio), is in the range of 1/9 to 9/1, the proportion of (a)+(b) in the aforementioned polymer (A) is 30 to 100 weight %, and the weight ratio of (B) to (A)+(B) is 2 to 30 weight %.

### BACKGROUND OF THE INVENTION

1. Field of the Invention

The present invention relates to a metal surface treatment agent which improves the press molding workability of metal materials and can form a coating film that is superior in terms of at least one of moisture resistance and coating film stripping characteristics, a surface-treated metal material, and a method of surface treating metal materials.

2. Background Art

In most cases, metal plates used in household electrical appliances, construction materials and other parts are manufactured by molding such as press molding, etc. Conventionally, in the case of such press molding, a method in which the metal plates are coated with a press-molding lubricating oil (press oil) and then molded, after which the press oil is removed by a degreasing and cleaning process using a solvent such as a chlorine type solvent, etc., has been widely used. Recently, however, deterioration of the working environment during the press oil coating process, and a response to regulation of the use of chlorine type solvents, etc., employed in degreasing, have begun to be viewed as important. Accordingly, in order to eliminate the abovementioned press oil coating process, so-called film removal type lubricating coating film treatment processes have been developed in which an organic coating film that provides a molding lubrication function is formed on the surfaces of the metal plates, molding such as press molding, etc., is performed, and the organic coating film is then removed by a method such as alkali degreasing, etc. In connection with such processes, various types of metal surface treatment agents and surface-treated metal plates have been proposed.

For example, a metal surface treatment agent in which a base resin containing a water-soluble resin with a glass transition temperature of 15 to 35° C. and a water-soluble resin with a glass transition temperature of 60 to 90° C. at a ratio of 4:6˜6:4 is mixed with a lubricating agent that has a melting point of 100° C. or greater at the rate of 2 to 10 parts by weight of the lubricating agent to 90 to 98 parts by weight of the base resin (Japanese Patent Application Kokai No. 54-18462), metal surface treatment agents consisting of a flexible and alkali-aqueous-solution-soluble water-soluble or water-dispersible resin, a solid lubricating agent and a body pigment or fluororesin powder (Japanese Patent Application Kokai No. 8-291294, Japanese Patent Application Kokai No. No. 10-152691), a surface treatment agent consisting of 20 to 50% alkali-soluble acrylic resin, 20 to 50% wax emulsion with a melting point of 50 to 130° C., and 10 to 40% alkali-soluble colloidal silica (Japanese Patent Application Kokai No. 10-88364), and a method in which a lower-layer coating film with a thickness of 1 to 60 μm consisting of an acrylic resin with an acid value of 40 to 400 and a glass transition temperature of −10 to 30° C., and an upper-layer coating film with a thickness of 3 to 60 μm consisting of an acrylic resin with an acid value of 40 to 400 and a glass transition temperature of 40 to 80° C., are successively formed on the surfaces of stainless steel plates (Japanese Patent Application Kokai No. 8-156177), etc., have been proposed.

However, in the case of these metal surface treatment agents and other surface-treated metal materials proposed in the past, although the press molding workability of the metal materials is improved, there have been problems in terms of build-up resulting from the deposition of coating film constituent resins on press molding tools and rolls installed downstream from the oven outlet in the painting line, mold sticking of the metal plate surfaces caused by substances admixed in the coating film, and blocking of the metal plates with each other caused by tacky adhesion of the coating film surfaces during storage, as well as problems arising from the physical properties of the coating films, such as the need for a considerable amount of time for the degreasing treatment, and the fact that the coating film stripping characteristics are inferior, etc. Thus, the abovementioned metal surface treatment agents and surface-treated metal materials still cannot be said to be adequate.

### SUMMARY OF THE INVENTION

The object of the present invention is to solve the abovementioned problems encountered in the prior art, and to provide a metal surface treatment agent which improves the press molding workability of metal materials, and which can form a coating film that is superior in terms of at least one of moisture resistance and coating film stripping characteristics, and a surface-treated metal material which is surface-treated with this metal surface treatment agent, and a method of surface treating metal materials.

The inventors of the present invention have discovered that the aforementioned problems can be solved by using a metal surface treatment agent that contains a lubricating agent and a copolymer that has a specified chemical structure.

The present invention provides a metal surface treatment agent which comprises (A) a copolymer which comprises (a) styrene and (b) a vinyl compound with carboxyl groups that is copolymerizable with styrene, and (B) a lubricating agent. The (A) copolymer has a weight ratio of component (a) to component (b) i.e., (a)/(b) (weight ratio), is in the range of 1/9 to 9/1, a proportion of (a)+(b) in the polymer (A) of 30 to 100 weight %, and a ratio of (B) to (A)+(B) of 2 to 30 weight %. It is desirable that the abovementioned lubricating agent (B) comprises at least one substance selected from the group consisting of paraffin wax, microcrystalline wax, polyethylene wax and polypropylene wax. Furthermore, it is desirable that the abovementioned polymer (A) be a polymer with a glass transition temperature of 75° C. or greater. Moreover, the present invention also provides a surface-treated metal material with superior press molding workability and/or coating film stripping characteristics and a method of making the same by coating the surface of a metal material with the aforementioned metal surface treatment agent so that the amount of adhering coating film following drying is 0.1 to 5 μm², and then drying the aforementioned metal surface treatment agent.

### DETAILED DESCRIPTION OF THE PREFERRED EMBODIMENT(S)

First, the polymer (A) used in the present invention will be described. The polymer (A) is a copolymer which contains (a) styrene, and (b) a vinyl compound with carboxyl groups that is copolymerizable with styrene, as essential monomers. The abovementioned component (b) is a vinyl compound with carboxyl groups that is copolymerizable with styrene; suitable examples of such compounds include, but are not necessarily limited to, acrylic acid, methacrylic acid, maleic acid, maleic anhydride, fumaric acid, crotonic acid, itaconic acid, citraconic acid and cinnamic acid, and the like.

The weight ratio of the abovementioned styrene (a) to the vinyl compound (b) containing carboxyl groups that is copolymerizable with styrene, i.e., (a)/(b) (weight ratio), is in the range of 1/9 to 9/1, preferably in the range of 2/8 to 8/2, and even more preferably in the range of 5/5 to 8/2. In cases where the (a)/(b) (weight ratio) is less than 1/9 (i.e., in cases where the amount of styrene is small), the workability of the coating film deteriorates; specifically, the hardness of the coating film is insufficient so that the coating film is susceptible to damage during press molding. Accordingly, such a small ratio is undesirable. On the other hand, in cases where (a)/(b) (weight ratio) exceeds 9/1 (i.e., in cases where the amount of styrene is large), the coating film stripping characteristics deteriorate. Accordingly, such a large ratio is undesirable.

Furthermore, the proportion of (a)+(b) in the polymer (A), i.e., the proportion of the total amount of component (a) plus component (b) in the polymer (A), is 30 to 100 weight %, preferably 40 to 100 weight %, and even more preferably 50 to 100 weight %. In cases where the proportion of (a)+(b) in the polymer (A) is less than 30 weight %, the amount of styrene in the polymer is too small; as a result, the workability of the coating film deteriorates. Accordingly, such a small proportion is undesirable.

There are no particular restrictions on copolymerizable compounds other than components (a) and (b) contained in the polymer (A) used in the present invention; examples of desirable compounds include, but are not necessarily limited to, aliphatic alcohol esters of acrylic acid, methacrylic acid, maleic acid, fumaric acid, crotonic acid and itaconic acid, etc., e.g., methyl (meth)acrylate, ethyl (meth)acrylate, butyl (meth)acrylate, 2-ethylhexyl (meth)acrylate, mono- or dimethyl maleate, mono- or diethyl maleate, mono- or dibutyl maleate, mono- or dimethyl fumarate, mono- or diethyl fumarate, mono- or dibutyl fumarate, methyl crotonate, ethyl crotonate, butyl crotonate, mono- or dimethyl itaconate, mono- or diethyl itaconate, and mono- or dibutyl itaconate, etc. In addition, acrylonitrile, methacrylonitrile, vinyl acetate, acrylamide and diacetoneacrylamide, etc., may also be used. Furthermore, there are no particular restrictions on the method used to polymerize the polymer of the present invention; ordinary methods used to polymerize vinyl compounds, e.g., emulsion polymerization, suspension polymerization or solution polymerization methods, are desirable.

In regard to the polymer (A) used in the present invention, a polymer with a glass transition temperature of 75° C. or greater, preferably 80° C. or greater, is suitable for use. Typically, the temperature of the surface of the material during press molding is ordinarily around 80° C. Consequently, if the glass transition temperature of the resin in the coating film is too low, the coating film may be damaged during press molding. Accordingly, it is desirable that the glass transition temperature of the resin in the coating film be 75° C. or greater.

Examples of substances which can be used as the lubricating agent (B) used in the present invention include, but are not necessarily limited to, paraffin wax, paraffin wax derivatives, microcrystalline wax, microcrystalline wax derivatives, polyethylene wax, polypropylene wax, candelilla wax, carnauba wax, rice wax, Japan wax, hohoba wax, beeswax, lanolin, spermaceti, montan wax, montan wax derivatives, ozocerite, ceresin, petrolatum, hardened castor oil, hardened castor oil derivatives, stearic acid amide and anhydrous phthalic acid amide, etc. Among these substances, paraffin wax, microcrystalline wax, polyethylene wax and polypropylene wax are especially preferred.

The metal surface treatment agent of the present invention is manufactured by adding the abovementioned polymer (A) and lubricating agent (B) to water, and mixing these ingredients so that the ingredients are dissolved or dispersed. There are no particular restrictions on the order in which the respective components are added; however, it is appropriate to mix the ingredients by agitation using (for example) a propeller agitator, etc. In regard to the proportions of the polymer (A) and lubricating agent (B), the ratio of (B) to (A)+(B) (in terms of solid content) is 2 to 30 weight %, preferably 3 to 25 weight %, and even more preferably 5 to 20 weight %. In cases where the ratio of the solid content of (B) to the total solid content of (A)+(B) is less than 2 weight %, the effect of the lubricating agent during press molding is insufficient. On the other hand, in cases where this ratio exceeds 30 weight %, the coating film stripping characteristics deteriorate since the lubricating agent is insoluble in water. Accordingly, such a high ratio is undesirable.

Furthermore, in the metal surface treatment agent of the present invention, it is desirable that the concentration of the solid content be in the range of 5 to 50 weight %, and a concentration in the range of 5 to 40 weight % is even more desirable. In cases where the concentration of the solid content is less than 5 weight %, the drying time is prolonged when a coating film is formed by applying the agent to the surface of the metal material. Accordingly, such a small concentration is undesirable. On the other hand, if the concentration of the solid content exceeds 50 weight %, the viscosity of the metal surface treatment agent itself is increased, so that there is a danger that handling of the agent will be adversely affected. Surfactants known as wettability-improving agents, which are used to form a uniform coating film on the coated surface, conductive substances that are used to improve weldability, and coloring pigments used to improve design properties, etc., may also be contained in the metal surface treatment agent of the present invention as optional components.

The above mentioned coating film stripping characteristics are a performance value that is necessary in cases where the metal material is used in applications requiring special features of the material (e.g., external appearance, vividness) or treatability in after-processes (e.g., phosphate formation treatments, alumite treatments), etc. In such cases, it is necessary that it be possible to strip the coating film by means of a treatment such as alkali degreasing, etc. In the case of conventional coating films of this type, the coating film can be stripped by means of alkali degreasing, and the like; however, the moisture resistance is insufficient, and the coating film becomes tacky as a result of being exposed to moisture in the air during the period between the application of the coating to the metal material and the molding process, so that there is a danger of blocking of the metal plates. As result, the metal plates must be stored under strict moisture control. In the case of the coating film of the present invention, on the other hand, as a result of the components in the polymer (A) being specified, stripping of the coating film can be accomplished by alkali degreasing, and the moisture resistance is improved. Consequently, there is no need for strict moisture control during the storage period between application of the coating to the metal material and the molding process. Accordingly, metal materials on which a coating film is formed using the surface treatment agent of the present invention are superior in terms of workability to metal materials on which a coating film is formed using a conventional surface treatment agent.

There are no particular restrictions on the metal materials treated with the metal surface treatment agent of the present invention; examples of desirable metal materials include, but are not necessarily limited to, galvanized steel plates (electro-galvanized steel plates, melt-galvanized steel plates, alloyed melt-galvanized steel plates, galvanized steel plates containing 5% aluminum, galvanized steel plates containing 55% aluminum, vacuum deposition type galvanized steel plates), aluminum plates, aluminum alloy plates, cold-rolled steel plates and stainless steel plates, and the like.

The surface treatment agent of the present invention is applied the above mentioned metal material at a temperature of 10 to 40° C. The coating to method used may be a roll coater method, dipping method or electrostatic coating method, and the like. Following coating, drying is performed with the temperature reached by the plates set at 50 to 180° C., preferably 60 to 160° C., and even more preferably 60 to 140° C. A coating film with superior coating film stripping characteristics can be formed on the surfaces of metal materials, and metal materials on which such a coating film is formed are superior in terms of press molding characteristics. In cases where the above mentioned temperature reached by the plates during drying is less than 50° C., the coating film is sticky; accordingly, such a low temperature is undesirable. On the other hand, in cases where the temperature reached by the plates exceeds 180° C., the cost involved in drying is increased so that such a process is uneconomical.

When a coating film is formed by coating the surface of a metal material with the surface treatment agent of the present invention, the aforementioned surface treatment agent is applied and dried so that the amount of adhering coating film following drying is 0.1 to 5 g/m². This amount of adhering coating film is preferably 0.2 to 4 g/m², and is even more preferably 0.3 to 3 g/m². In cases where the amount of the adhering resin coating film layer is less than 0.1 g/m², satisfactory press molding characteristics cannot be obtained. On the other hand, in cases where this amount exceeds 5 g/m², the effect on the press molding characteristics becomes saturated; accordingly, such a large amount is uneconomical.

The present invention will be described below in terms of working examples and comparative examples. These working examples are described in order to illustrate the present invention, and do not limit the present invention in any way.

### EXAMPLES

Preparation of Test Plates

(1) Test Materials

The commercially marketed metal materials shown below were used as test materials. Furthermore, the size of the test materials was 200 mm×300 mm.

Electro-galvanized steel plates (EG)

Plate thickness: 0.8 mm, amount of zinc plating=20/20 (g/m²)

Aluminum plates (AL)

Plate thickness: 0.8 mm, 5182 series

Cold-rolled steel plates (SPC)

Plate thickness: 0.8 mm, JIS-G-3141

(2) Degreasing Treatment

The abovementioned test materials were subjected to a degreasing treatment with Fine Cleaner 4336 (registered trademark, manufactured by Nihon Parkerizing Co Ltd.), a silicate type alkali degreasing agent. Specifically, the test materials were subjected to a spray treatment for 2 minutes at a degreasing agent concentration of 20 g/L and a temperature of 60° C., and were then washed with tap water for 30 seconds.

Preparation of Surface Treatment Agents

Copolymers A1 through A8 were prepared by copolymerizing the monomers shown in Table 1 in the proportions shown in Table 1 (the numerals in parentheses shown for the monomers in Table 1 indicate weight ratios). Copolymerization was accomplished by emulsion polymerization using an ordinary method at room temperature. The copolymers were used as aqueous dispersions with a solid content concentration of 20-weight %. Copolymers A1 through A8 shown in Table 1 and lubricating agents B1 through B3 shown in Table 2 were mixed in the compositions and amounts shown in Table 3 while being agitated by means of a propeller agitator in the order shown, and the concentration of the solid content was adjusted by adding distilled water. In this way, the metal surface treatment agents of Working Examples a through j and the metal surface treatment agents of Comparative Examples k through n were prepared.

TABLE 1
Monomer composition of polymer

| | | | | | [Ratio of] | [Sum of] | Glass |
|---|---|---|---|---|---|---|---|
| | | | | | (a)/(b) in | (a) + (b) in | transition |
| Polymer | Component (a) | Component (b) | Other components | | polymer (A) | polymer (A) | temperature |
| A1 | Styrene(40) | Acrylic acid(40) | Methyl acrylate(10) | Methyl methacrylate(10) | 1/1 | 80 | 91EC |
| A2 | Styrene(30) | Maleic acid(30) | Dimethyl maleate(10) | Diethyl maleate(30) | 1/1 | 60 | 85EC |
| A3 | Styrene(48) | Acrylic acid(32) | Butyl acrylate(10) | Methyl methacrylate(10) | 3/2 | 80 | 78EC |
| A4 | Styrene(25) | Maleic acid(75) | — | — | 3/1 | 100 | 123EC |
| A5 | Styrene(72) | Acrylic acid( 8) | Methyl acrylate(10) | Methyl methacrylate(10) | 9/1 | 80 | 91EC |
| A6 | Styrene( 8) | Acrylic acid(72) | Methyl acrylate(10) | Methyl methacrylate(10) | 1/9 | 80 | 109EC |
| A7 | Styrene( 0) | Acrylic acid(50) | Butyl acrylate(25) | Methyl methacrylate(25) | 0/10 | 50 | 47EC |
| A8 | Styrene(60) | Maleic acid( 4) | Butyl acrylate(18) | Methyl methacrylate(18) | 15/1 | 64 | 59EC |

TABLE 2

| Lubricating | | Solid Content |
|---|---|---|
| Agent | Type | Concentration |
| B1 | Polyethylene wax (commercial name: | 40% |
| | Chemival W900, manufactured by Mitsui | |
| | Chemicals.) | |
| B2 | Paraffin wax (commercial name: Cerosol | 50% |
| | 428, manufactured by Chukyo | |
| | Yushi K.K.) | |
| B3 | Microcrystalline wax (commercial name: | 50% |
| | Cerosol 967, manufactured by Chukyo | |
| | Yushi K.K.) | |

TABLE 3

| | | Metal Surface Treatment Agent | | | |
|---|---|---|---|---|---|
| | | Polymer (A) | | Lubricating Agent (B) | |
| | | Type | Amount¹ | Type | Amount¹ |
| WORKING | a | A1 | 80 | B1 | 20 |
| EXAMPLES | b | A2 | 80 | B1 | 20 |
| | c | A3 | 80 | B1 | 20 |
| | d | A4 | 80 | B1 | 20 |
| | e | A5 | 80 | B1 | 20 |
| | f | A6 | 80 | B1 | 20 |
| | g | A1 | 80 | B2 | 20 |
| | h | A2 | 80 | B3 | 20 |
| | i | A3 | 95 | B1 | 5 |
| | j | A4 | 70 | B2 | 30 |
| COMPARATIVE | k | A7 | 80 | B1 | 20 |
| EXAMPLES | l | A8 | 80 | B1 | 20 |
| | m | A3 | 99 | B1 | 1 |
| | n | A4 | 60 | B1 | 40 |

¹Weight % of solid content of respective components (A) and (B) relative to solid content (A) + (B) of metal surface treatment agent.

Method Used to Apply the Surface Treatment Agents to the Test Plates

The respective surface treatment agents prepared as described above were applied to the abovementioned test plates by means of a bar coater, and were dried for 10 seconds at an atmosphere temperature of 240° C. The temperature reached by the plates in this case was 100 C. The amount of adhering surface treatment agent was adjusted by appropriately varying the concentration of the solid content of the surface treatment agent and the type of bar coater used.

Coated Plate Performance Tests

(1) Press Molding Characteristics

The test samples were cut to a size of 30 mm×300 mm, and a draw-bead test (bead tip end 1 mm R, bead height 4 mm, die shoulder 1 mm R, pressure bonding load 500 kg, temperature 30° C.) was performed. The rubbed surface was stripped with cellophane tape, and an evaluation was performed using the criteria shown below.

Evaluation Criteria

⊚: no adhesion of coating film to cellophane tape

∘: very slight adhesion of coating film to cellophane tape

Δ: adhesion of coating film to cellophane tape, little damage of coating film on rubbed surface

x: extensive damage of coating film on rubbed surface

(2) Moisture Resistance

The test samples were cut to a size of 70 mm×150 mm, and were allowed to stand for 5 hours in an atmosphere at a temperature of 50° C. and a humidity of 95%. The external appearance before and after testing was evaluated using the criteria shown below.

Evaluation Criteria

⊚: no dissolution or color change of coating film

∘: no dissolution of coating film; however, color change observed

Δ: coating film slightly dissolved

x: coating film dissolved

(3) Coating Film Stripping Characteristics

The test samples were cut to a size of 70 mm×150 mm, and were subjected to a degreasing treatment using Fine Cleaner 4336 (registered trademark, manufactured by Nihon Parkerizing Co., Ltd.), a silicate type alkali degreasing agent. Specifically, the test samples were subjected to a spray treatment for 2 minutes at a degreasing agent concentration of 20 g/L and a temperature of 60° C., and were then washed with tap water. Following washing, the amount of surface carbon on the test samples was measured using a LECO (surface carbon analyzer), and the degree of coating film stripping was calculated using the formula shown below. An evaluation was then performed using the criteria shown below. Furthermore, “before degreasing”, “after degreasing” and “untreated plates” in the formula indicate the respective amounts of carbon on the surfaces of the test samples.

Degree of Coating Film Stripping

Degree of coating film stripping (%)=[(before degreasing−after degreasing)/(before degreasing−untreated plates)]×100

Evaluation Criteria

⊚: degree of coating film stripping is 98% or greater

∘: degree of coating film stripping is 95% or greater, but less than 98%

Δ: degree of coating film stripping is 80% or greater, but less than 95%

x: degree of coating film stripping is less than 80%

As is clear from the test results shown in Table 4 below, the workability, moisture resistance and coating film stripping characteristics were all good in Working Examples 1 through 14, which used metal surface treatment agents of the present invention. On the other hand, in Comparative Examples 1 through 4, which used metal surface treatment agents outside the ranges of the present invention, materials that simultaneously satisfied all of the performance requirements for workability, moisture resistance and coating film stripping characteristics could not be obtained.

TABLE 4

| | | | Metal surface | | | Coated plane | | |
|---|---|---|---|---|---|---|---|---|
| | | | treatment agent | | | performance values | | |
| | | | | Amount | Temperature | Press | | Coating film |
| | | | | adhearing | reached by | molding | Moisture | stripping |
| | | Material | Type | g/m² | plates ° C. | characteristics | resistance | characteristics |
| Working | 1 | EG | a | 1.0 | 100 | ⊚ | ⊚ | ⊚ |
| Examples | 2 | AL | b | 1.0 | 100 | ⊚ | ⊚ | ⊚ |
| | 3 | SPC | c | 1.0 | 100 | ⊚ | ⊚ | ⊚ |
| | 4 | EG | d | 1.0 | 100 | ⊚ | ⊚ | ⊚ |
| | 5 | AL | e | 1.0 | 100 | ⊚ | ⊚ | ⊚ |
| | 6 | SPC | f | 1.0 | 100 | ⊚ | ⊚ | ⊚ |
| | 7 | EG | g | 1.0 | 100 | ⊚ | ⊚ | ⊚ |
| | 8 | AL | h | 1.0 | 100 | ⊚ | ⊚ | ⊚ |
| | 9 | SPC | i | 1.0 | 100 | ⊚ | ⊚ | ⊚ |
| | 10 | EQ | j | 1.0 | 100 | ⊚ | ⊚ | ⊚ |
| | 11 | AL | k | 0.5 | 100 | ◯ | ⊚ | ⊚ |
| | 12 | SPC | l | 3.0 | 100 | ⊚ | ⊚ | ⊚ |
| | 13 | EG | m | 1.0 | 70 | ⊚ | ⊚ | ⊚ |
| | 14 | AL | n | 1.0 | 150 | ⊚ | ⊚ | ⊚ |
| Comparative | 1 | SPC | o | 1.0 | 100 | Δ | X | Δ |
| Examples | 2 | EG | p | 1.0 | 100 | Δ | Δ | X |
| | 3 | AL | q | 1.0 | 100 | Δ | ◯ | ◯ |
| | 4 | SPC | r | 1.0 | 100 | ◯ | ◯ | X |

Thus, a coating film which is superior in terms of at least one of moisture resistance and coating film stripping characteristics can be formed on the surfaces of metal materials by applying the metal surface treatment agent of the present invention to the surfaces of such metal materials and drying the applied agent. The metal materials on which such coating films are formed are superior in terms of press molding characteristics. Furthermore, since the coating films formed on the surfaces of the metal materials are superior in terms of moisture resistance, no blocking occurs during the storage of the metal materials up to the time of press molding, even if the humidity is not strictly controlled. Moreover, since the coating films formed on the surfaces of the metal materials are superior in terms of coating film stripping characteristics, the metal surface treatment agent of the present invention brings out the special features of materials such as external appearance and vivid color, etc., and can be suitably utilized in the treatment of metal materials that require after-process treatments such as phosphate formation treatments or alumite treatments, etc.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A metal surface treatment agent which comprises (A) a copolymer which comprises (a) styrene and (b) a vinyl compound with carboxyl groups that is copolymerizable with styrene, and (B) a lubricating agent, the (A) copolymer having a weight ratio of component (a) to component (b) in the range of 1/9 to 9/1, with (a)+(b) being present in polymer (A) in an amount of 30 to 100 weight %, and the ratio of (B) to (A)+(B) being 2 to 30 weight %.

2. The metal surface treatment agent claimed in claim 1, in which the lubricating agent (B) comprises at least one substance selected from the group consisting of paraffin wax, microcrystalline wax, polyethylene wax and polypropylene wax.

3. The metal surface treatment agent claimed in claim 1, in which the glass transition temperature of the polymer (A) is 75° C. or higher.

4. The metal surface treatment agent claimed in claim 2, in which the glass transition temperature of the polymer (A) is 75° C. or higher.

5. A surface-treated metal material with superior press molding workability and/or coating film stripping characteristics which is formed by coating a surface of the metal material with a metal surface treatment agent comprising (A) a copolymer which comprises (a) styrene and (b) a vinyl compound with carboxyl groups that is copolymerizable with styrene, and (B) a lubricating agent, with the (A) copolymer having a weight ratio of component (a) to component (b) in the range of 1/9 to 9/1, with (a)+(b) being present in polymer (A) in an amount of 30 to 100 weight %, and the ratio of (B) to (A)+(B) being 2 to 30 weight %, and then drying the metal surface treatment agent, with the amount of adhering film following drying being 0.1 to 5 g/m².

6. The metal material of claim 5 wherein the lubricating agent (B) comprises of at least one substance selected from the group consisting of paraffin wax, microcrystalline wax, polyethylene wax and polypropylene wax.

7. The metal material of claim 5 wherein the glass transition temperature of the polymer (A) is 75° C. or higher.

8. The metal material of claim 6 wherein the glass transition temperature of the polymer (A) is 75° C. or higher.

9. A method of surface treating a metal material, said method comprising coating a surface of the metal material with the metal surface treatment agent of claim 1 and drying the metal surface agent to form a film of 0.1 to 5 g/m² adhering to the surface.

10. The method of claim 9, in which the lubricating agent (B) comprises at least one substance selected from the group consisting of paraffin wax, microcrystalline wax, polyethylene wax and polypropylene wax.

11. The method of claim 9, in which the glass transition temperature of the polymer (A) is 75° C. or higher.

12. The method of claim 10, in which the glass transition temperature of the polymer (A) is 75° C. or higher.
